(19) United States
(12) Patent Application Publication
(10) Pub. No.: US 2026/0045476 A1
(43) Pub. Date: Feb. 12, 2026

(54) ELECTRODE MANUFACTURING EQUIPMENT FOR RECHARGEABLE BATTERY

(71) Applicant: PROTEC CO., LTD., Gyeonggi-do (KR)

(72) Inventor: Youn Sung Ko, Gyeonggi-do (KR)

(73) Assignee: PROTEC CO., LTD., Gyeonggi-do (KR)

(21) Appl. No.: 19/292,949

(22) Filed: Aug. 7, 2025

(30) Foreign Application Priority Data
Aug. 7, 2024 (KR) 10-2024-0105268

(51) Int. Cl. H01M 4/04

(52) U.S. Cl. CPC H01M 4/0435

(57) ABSTRACT

Provided is an apparatus for manufacturing an electrode for a rechargeable battery, and more particularly, to an apparatus for manufacturing an electrode for a rechargeable battery used in manufacturing a rechargeable battery. The electrode manufacturing apparatus for rechargeable batteries of the present disclosure enables the notching process of electrode films for manufacturing electrodes for rechargeable batteries used in the manufacture of a rechargeable battery, with high quality. Additionally, the electrode manufacturing apparatus for rechargeable batteries of the present disclosure enables the manufacture of an apparatus capable of performing notching processes on electrode films with high quality and high productivity, at low costs.

### CROSS-REFERENCE TO RELATED APPLICATION

This application is based on and claims priority under 35 USC § 119 to Korean Patent Application No. 10-2024-0105268, filed on Aug. 7, 2024, in the Korean Intellectual Property Office, the disclosure of which is incorporated by reference herein in its entirety.

### BACKGROUND

### Field

The present disclosure relates to an apparatus for manufacturing an electrode for a rechargeable battery, and more particularly, to an apparatus for manufacturing an electrode for a rechargeable battery used in manufacturing a rechargeable battery.

### Description of the Related Art

Rechargeable batteries have many advantages, including high energy density, high operating voltage, and excellent storage and life characteristics, and are therefore widely used not only in various portable electronic devices such as personal computers, camcorders, portable telephones, portable compact disc (CD) players, and personal digital assistants (PDAs), but also in electric vehicles and the like.

Examples of rechargeable batteries include nickel-cadmium batteries, nickel-hydrogen batteries, lithium batteries, and the like, wherein lithium rechargeable batteries can be manufactured to have higher energy density and longer life compared to other types of rechargeable batteries, and are thus used in many fields.

A lithium rechargeable battery includes a case filled with electrolyte and an electrode assembly accommodated inside the case. The electrode assembly is formed by stacking an anode, a separator, and a cathode, and has a jelly-roll type winding structure or a stack structure.

Generally, the electrode plates of lithium rechargeable batteries undergo a coating process in which an anode material or a cathode material is coated on aluminum or copper film and dried to manufacture the anode or cathode, followed by a notching process in which the anode or cathode material is removed from each electrode plate portion (also called an uncoated portion) where the anode or cathode material is not coated, leaving a portion for grounding a tab.

In the notching process, a cutting process is also performed in which the electrode film subjected to the notching process is cut to unit cell size to provide electrode sheets.

Although a method using a laser is widely used in the notching process, contaminants or harmful substances are generated during the laser cutting process. Additionally, there are process management difficulties in that it is difficult to synchronize and operate the electrode sheet and the laser beam with each other during laser notching processing.

A method of notching by pressing electrode sheets using a notching mold is also used. In this case, after manufacturing the notching mold in an electrode form, the electrode is punched by a method of raising and lowering the notching mold relative to the electrode sheet to apply pressure. In this case, process costs increase because new molds must be manufactured each time for different electrode sizes and shapes, and there is also a problem of low productivity. Additionally, the lifespan of the mold is not long due to the pressure applied to the mold, and in this case, the cost of manufacturing new molds each time increases.

### SUMMARY

Provided is an electrode manufacturing apparatus for rechargeable batteries having a structure capable of effectively performing a notching process while extending the lifespan of molds.

An electrode manufacturing apparatus for a rechargeable battery that notches an electrode film so as to form an electrode sheet by punching the electrode film, includes a first pressing roller formed in a cylindrical shape and installed to be rotatable, a second pressing roller disposed in parallel so as to face the first pressing roller with a spacing therebetween and installed to be rotatable, a first notching member having a first notching portion in the form of the electrode sheet and formed in a flat plate shape and detachably installed on the first pressing roller so as to be capable of notching by pressing the electrode film passing between the first pressing roller and the second pressing roller against the second pressing roller, and a second notching member having a second notching portion formed in a shape corresponding to the first notching portion and formed in a flat plate shape and detachably installed on the second pressing roller.

An electrode manufacturing apparatus for a rechargeable battery that notches an electrode film so as to form an electrode sheet by punching the electrode film, includes a first pressing roller formed in a cylindrical shape and installed to be rotatable, a second pressing roller disposed in parallel so as to face the first pressing roller with a spacing therebetween and installed to be rotatable; and a notching member having a notching portion in the form of the electrode sheet and formed in a flat plate shape and detachably installed on the first pressing roller so as to be capable of notching by pressing the electrode film passing between the first pressing roller and the second pressing roller against the second pressing roller.

### BRIEF DESCRIPTION OF THE DRAWINGS

These and/or other aspects will become apparent and more readily appreciated from the following description of the embodiments, taken in conjunction with the accompanying drawings in which:

FIG. 1 is a perspective view of an electrode manufacturing apparatus for a rechargeable battery according to the first embodiment of the present disclosure;

FIG. 2 is an exploded perspective view of the electrode manufacturing apparatus for rechargeable batteries shown in FIG. 1.

FIG. 3 is a cross-sectional view for explaining the operation of the electrode manufacturing apparatus for a rechargeable battery shown in FIG. 1;

FIG. 4 is a perspective view of an electrode manufacturing apparatus for a rechargeable battery according to a second embodiment of the present disclosure; and

FIG. 5 is an exploded perspective view of the electrode manufacturing apparatus for a rechargeable battery shown in FIG. 4.

### DETAILED DESCRIPTION

Below, with reference to the attached drawings, an electrode manufacturing apparatus for rechargeable batteries according to the present disclosure is described in detail.

First, referring to the drawings, the structure of the electrode manufacturing apparatus for a rechargeable battery according to the first embodiment of the present disclosure is described.

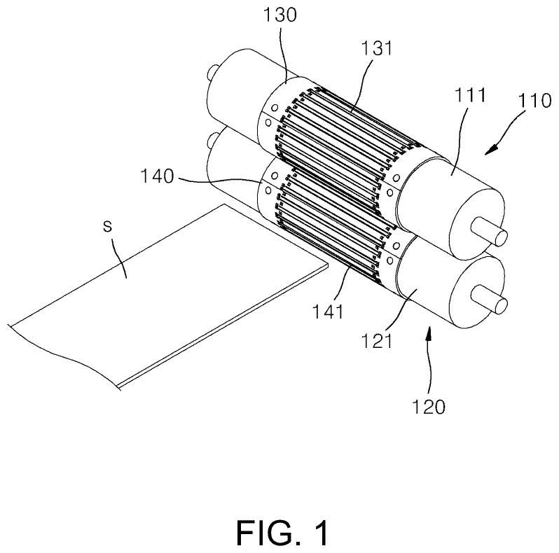

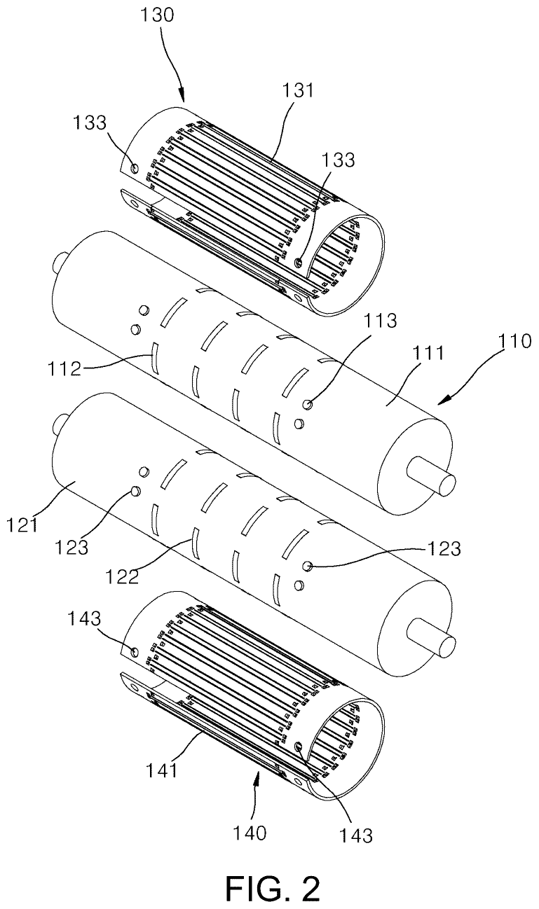

FIG. 1 is a perspective view of an electrode manufacturing apparatus for a rechargeable battery according to the first embodiment of the present disclosure, and FIG. 2 is an exploded perspective view of the electrode manufacturing apparatus for rechargeable batteries shown in FIG. 1.

An electrode manufacturing apparatus for a rechargeable battery according to the first embodiment comprises a first pressing roller 110, a second pressing roller 120, a first notching member 130, and a second notching member 140.

The first pressing roller 110 and the second pressing roller 120 are arranged parallel to each other and installed close to each other. The first pressing roller 110 and the second pressing roller 120 are rotatably installed in a state where both ends thereof are supported by a support member (not shown). The support member is configured to enable adjustment of the spacing between the first pressing roller 110 and the second pressing roller 120 and supports the first pressing roller 110 and the second pressing roller 120.

The first pressing roller 110 may include a first roller body 111 and a first magnet portion 112. The first roller body 111 is formed in a cylindrical shape with a constant outer diameter along the longitudinal direction. The first magnet portion 112 may include a magnet having magnetism and may be installed on the first roller body 111. In the present embodiment, the first magnet portion 112 is provided as a plurality of first magnet portions and are installed so as to be exposed on the surface of the first roller body 111 and are distributed at regular intervals.

The second pressing roller 120 is also configured in a similar shape to the first pressing roller 110. The second pressing roller 120 may include a second roller body 121 and a second magnet portion 122. The second roller body 121 is formed in a cylindrical shape with a constant outer diameter along the longitudinal direction. The second magnet portion 122 may include a magnet having magnetism and is installed on the second roller body 121. In the present embodiment, the second magnet portion 122 is provided as a plurality of second magnet portions and are installed so as to be exposed on the surface of the second roller body 121 and are distributed at regular intervals.

The first notching member 130 is formed in the shape of a metal plate and is detachably installed relative to the first pressing roller 110. In the present embodiment, the first notching member 130 is installed relative to the first pressing roller 110 in such a way that the first notching member 130 is attached by the magnetism of the first magnet portion 112 of the first pressing roller 110. For this purpose, the first notching member 130 may include a ferromagnetic material that adheres to a magnet. In addition, the first notching member 130 may include a material that is elastically bent so as to be bent and attached to the outer diameter of the first roller body 111. A first notching part 131 may be formed on the surface of the first notching member 130. The first notching part 131 may be formed in the shape of a blade having a pattern in the shape of an electrode sheet so as to pressurize an electrode film S passing between the first pressing roller 110 and the second pressing roller 120 and notch the same into the shape of an electrode sheet. The first notching member 130 may be manufactured in various ways. In the present embodiment, the first notching member 130 may be manufactured by etching the remaining portion except for the first notching part 131 using an etching method.

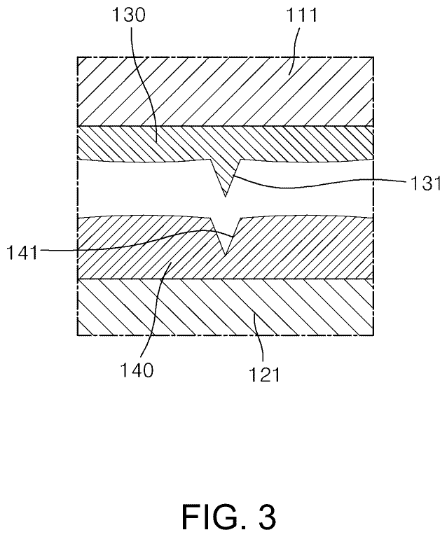

The second notching member 140 may also be formed in the shape of a metal plate and is detachably installed relative to the second pressing roller 120. The second notching member 140 may also be detachably installed relative to the second pressing roller 120 by being attached by the magnetism of the second magnet portion 122 of the second pressing roller 120. The second notching member 140 may include a ferromagnetic material. In addition, the second notching member 140 may include a material that is elastically bent so as to be bent and attached to the outer diameter of the second roller body 121. A second notching part 141 may be formed on the surface of the second notching member 140. The second notching part 141 is formed in a shape corresponding to the first notching part 131. Referring to FIG. 3, the second notching part 141 may be formed concavely so that the protruding portion of the first notching part 131 is accommodated at a corresponding position so that the second notching part 141 effectively supports the corresponding portion of the electrode film S when the first notching part 131 in the shape of a blade penetrates and notches the electrode film S.

Referring to FIG. 2, a guide protrusion 113 and a guide groove 133 are formed on the first pressing roller 110 and the first notching member 130, respectively, so as to fix the position of the first notching member 130 with respect to the first pressing roller 110. The first pressing roller 110 is formed with four guide protrusions 113 in the form of protrusions that protrude from the surface of the first roller body 111. The guide protrusions 113 may be positioned at positions corresponding to each of the four corners of the first notching member 130. Four guide grooves 133 may be formed in the first notching member 130. The guide grooves 133 may be positioned corresponding to the guide protrusions 113 of the first pressing roller 110. The guide grooves 133 may be formed to penetrate the first notching member 130. By arranging the first notching member 130 relative to the first pressing roller 110 so that the guide protrusions 113 are each fitted into the guide grooves 133 by this structure, the position of the first notching member 130 relative to the first pressing roller 110 is fixed. In other embodiments, the guide protrusions 113 and the guide grooves 133 may be formed at different locations. For example, a guide protrusion is formed on the first notching member 130 and a guide groove is formed on the first pressing roller 110.

A guide protrusion 123 and a guide groove 143 which have the same structures as described above may be formed on the second pressing roller 120 and the second notching member 140, respectively. By using this structure, the position of the second notching member 140 relative to the second pressing roller 120 may be easily fixed.

Hereinafter, a process of notching the electrode film S into a shape that is easy to cut an electrode sheet from the electrode film S using an electrode manufacturing apparatus for a rechargeable battery as described above will be described.

First, referring to FIG. 2, the first notching member 130 and the second notching member 140 are mounted on the first pressing roller 110 and the second pressing roller 120, respectively. As described above, by fitting the guide protrusion 113 of the first pressing roller 110 into the guide groove 133 of the first notching member 130, the position of the first notching member 130 with respect to the first pressing roller 110 may be accurately adjusted. In addition, since the first notching member 130 is attached by the first magnet portions 112 installed on the first pressing roller 110, the first notching member 130 is maintained in close contact with the first pressing roller 110. In the same way, the second notching member 140 is also mounted on the second pressing roller 120.

When the first notching member 130 and the second notching member 140 are mounted on the first pressing roller 110 and the second pressing roller 120, respectively, as shown in FIG. 1, the first pressing roller 110 and the second pressing roller 120 are installed so that they are close to each other in a parallel state. Considering the thickness of the electrode film S to be worked on, the gap between the first pressing roller 110 and the second pressing roller 120 may be adjusted.

In this state, as shown in FIG. 1, the end of the electrode film S is pushed between the first pressing roller 110 and the second pressing roller 120, and one of the first pressing roller 110 and the second pressing roller 120 is rotated. For example, in the present embodiment, the first pressing roller 110 is rotated. The first pressing roller 110 may be rotated manually or may be rotated by being connected to a motor. Even when an external force may be applied to rotate only one of the first pressing roller 110 and the second pressing roller 120, the other one may also engage and rotate duc to the pressing force and friction force on the electrode film S.

While the electrode film S advances while being engaged between the first pressing roller 110 and the second pressing roller 120, notching is formed in the electrode film S by the action of the first notching member 130 and the second notching member 140. In particular, even when the electrode film S is relatively thick, as shown in FIG. 3, the first notching part 131 and the second notching part 141 on opposite sides of the electrode film S are interlocked with each other in a male-female manner, so that notching can be performed on the electrode film S to a sufficient depth.

As described above, the electrode manufacturing apparatus for rechargeable batteries according to the present embodiment may perform the notching process by pressing the electrode film S using a roller structure, so there may be an advantage that notching work may be efficiently performed continuously and accurately on the electrode film S. Additionally, the present disclosure may have an advantage that the electrode notching process may be performed with high productivity and quality in accordance with the characteristics of the electrode film S without damaging an electrode portion of the electrode film S by adjusting the rotation speed of the rollers or the pressing force of the rollers.

In addition, since the first notching member 130 and the second notching member 140 are installed in a detachable form on the first pressing roller 110 and the second pressing roller 120, respectively, the pattern of the electrode film S for notching may be easily changed. When notching work is performed on the electrode film S for a long time, the first notching part 131 and the second notching part 141 may each wear out. In this case, the electrode manufacturing apparatus for rechargeable batteries according to the present embodiment may maintain the overall configuration including the first pressing roller 110 and the second pressing roller 120 as is and may use only newly manufactured and replaced first notching member 130 and second notching member 140, thereby having an effect of greatly reducing process costs. Instead of newly manufacturing and replacing the mold itself that may be formed in roller form, only the first notching member 130 and the second notching member 140 formed in thin flat plate form may be separately manufactured and replaced for use, thereby resulting in a substantial decrease in the mold replacement costs. In addition, as described above, the first notching member 130 and the second notching member 140 have the advantage of being able to be manufactured quickly and effectively by etching a metal plate, while at the same time being able to be manufactured precisely.

The above description may have been made with respect to preferred examples of the electrode manufacturing apparatus for rechargeable batteries according to the present disclosure, but the scope of the present disclosure may not be limited to the forms described and illustrated above.

For example, as described above, the first pressing roller 110 and the first notching member 130 are formed with the guide protrusion 113 and the guide groove 133, respectively, and the second pressing roller 120 and the second notching member 140 are formed with the guide protrusion 123 and the guide groove 143, respectively, but the positions of the first notching member 130 and the second notching member 140 with respect to the first pressing roller 110 and the second pressing roller 120 may be fixed by a method other than this configuration. For example, the first roller body of the first pressing roller and the second roller body of the second pressing roller may each use a structure in which a mounting portion is formed concavely in the first roller body and the second roller body. In this case, the first notching member and the second notching member may be respectively fitted into the mounting portions of the first pressing roller and the second pressing roller, such that the position of the first notching member and the position of the second notching member are fixed.

In addition, it has been described above that the first notching member 130 and the second notching member 140 are detachably installed on the first pressing roller 110 and the second pressing roller 120, respectively, by the first magnet portion 112 and the second magnet portion 122, but in some cases, it is possible to detachably install the first notching member and the second notching member on the first pressing roller and the second pressing roller, respectively, by using a different structure rather than the method using magnets. For example, the first notching member and the second notching member may be removably installed relative to the first pressing roller and the second pressing roller, respectively, using a fitting method, an adsorption method, or a separate fastening device.

In addition, the structures of the first notching member 130 and the second notching member 140 may be changed into various structures depending on the characteristics of the electrode film S, such as the thickness.

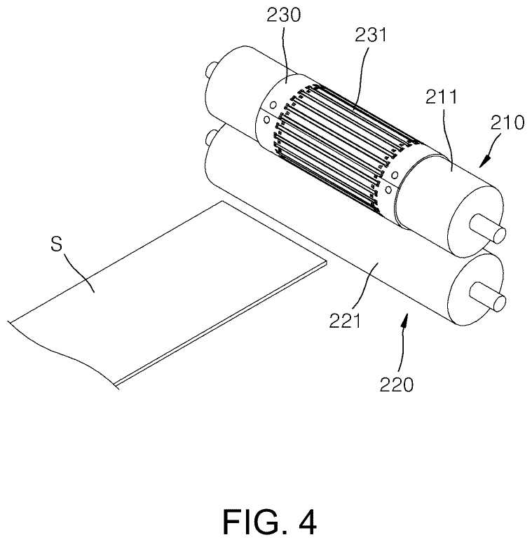

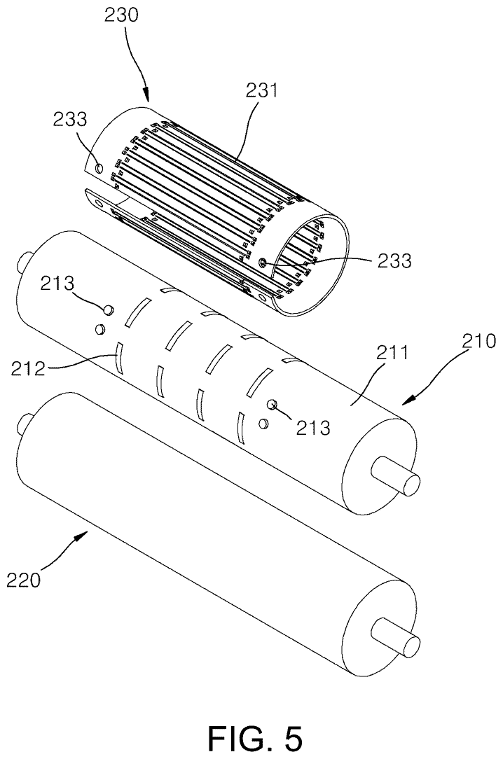

In addition, in some cases, it is also possible to construct and implement a rechargeable battery electrode manufacturing apparatus with a structure that does not include a second notching member, as illustrated in FIGS. 4 and 5. In particular, when the thickness of the electrode film S is relatively thin, the electrode manufacturing apparatus for a rechargeable battery according to the present disclosure can be implemented by installing a notching member 230 only on a first pressing roller 210 as shown in FIG. 4.

FIGS. 4 and 5 are views of an electrode manufacturing apparatus for a rechargeable battery according to the second embodiment of the present disclosure. As described above, the notching member 230 is installed on only one of the two pressing rollers. In this embodiment, the notching member 230 is detachably installed only on the first pressing roller 210. The first pressing roller 210 may include a first roller body 211 having a cylindrical shape. A magnet portion 212 may be installed on the first roller body 211 so that the notching member 230 may be detachably installed on the first roller body 211. A guide protrusion 213 is also formed on the first roller body 211 of the first pressing roller 210, and the guide protrusion 213 is fitted into a guide groove 233 of the notching member 230, thereby fixing the position of the notching member 230 with respect to the first pressing roller 210. A notching part 231 may be formed in the notching member 230. The second pressing roller 220 may include a second roller body 221 formed in a cylindrical shape. As the first pressing roller 210 rotates, the notching part 231 of the notching member 230 presses the electrode film S against the second pressing roller 220 to form a notching pattern in the form of an electrode sheet.

As described above, the electrode manufacturing apparatus for a rechargeable battery according to the second embodiment can also have various design modifications, such as detachable structure of the notching member and the formation structure of the notching part.

The electrode manufacturing apparatus for rechargeable batteries of the present disclosure enables the notching process of electrode films for manufacturing electrodes for rechargeable batteries used in the manufacture of a rechargeable battery, with high quality.

Additionally, the electrode manufacturing apparatus for rechargeable batteries of the present disclosure enables the manufacture of an apparatus capable of performing notching processes on electrode films with high quality and high productivity, at low costs.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope as defined by the following claims.

What is claimed is:

1. An electrode manufacturing apparatus for a rechargeable battery, notching an electrode film so as to form an electrode sheet by punching the electrode film, the electrode manufacturing apparatus comprising:
a first pressing roller formed in a cylindrical shape and installed to be rotatable;
a second pressing roller disposed in parallel so as to face the first pressing roller with a spacing therebetween and installed to be rotatable;
a first notching member having a first notching portion in the form of the electrode sheet and formed in a flat plate shape and detachably installed on the first pressing roller so as to be capable of notching by pressing the electrode film passing between the first pressing roller and the second pressing roller against the second pressing roller; and
a second notching member having a second notching portion formed in a shape corresponding to the first notching portion and formed in a flat plate shape and detachably installed on the second pressing roller.

2. The electrode manufacturing apparatus of claim 1, wherein
the first pressing roller includes a first roller body having a cylindrical shape and a first magnet portion installed on the first roller body and having magnetism,
the second pressing roller includes a second roller body having a cylindrical shape and a second magnet portion installed on the second roller body and having magnetism,
the first notching member is attached to the first pressing roller by the first magnet portion of the first pressing roller, and
the second notching member is attached on the second pressing roller by the second magnet portion of the second pressing roller.

3. The electrode manufacturing apparatus of claim 2, wherein
the first notching member includes a material and structure that are elastically bendable so as to be bent and attached to match an outer diameter of the first roller body by the magnetism of the first magnet portion of the first pressing roller, and
the second notching member includes a material and structure that are elastically bendable so as to be bent and attached to match an outer diameter of the second roller body by the magnetism of the second magnet portion of the second pressing roller.

4. The electrode manufacturing apparatus of claim 2, wherein
a guide protrusion in the form of a protrusion is formed on one of the first pressing roller and the first notching member and a guide groove into which the guide protrusion is fitted is formed on the other one of the first pressing roller and the first notching member so as to guide the position of the first notching member attached to the first pressing roller, and
another guide protrusion in the form of a protrusion is formed on one of the second pressing roller and the second notching member and another guide groove into which the another guide protrusion is fitted is formed on the other one of the second pressing roller and the second notching member so as to guide the position of the second notching member attached to the second pressing roller.

5. The electrode manufacturing apparatus of claim 1, wherein
mounting portions formed concavely in the first roller body and the second roller body are formed on the first roller body of the first pressing roller and the second roller body of the second pressing roller, respectively, and
the first notching member and the second notching member are respectively fitted into the mounting portions of the first pressing roller and the second pressing roller so that a position of each of the first notching member and the second notching member is fixed.

6. An electrode manufacturing apparatus for a rechargeable battery, notching an electrode film so as to form an electrode sheet by punching the electrode film, the electrode manufacturing apparatus comprising:
a first pressing roller formed in a cylindrical shape and installed to be rotatable;
a second pressing roller disposed in parallel so as to face the first pressing roller with a spacing therebetween and installed to be rotatable; and
a notching member having a notching portion in the form of the electrode sheet and formed in a flat plate shape and detachably installed on the first pressing roller so as to be capable of notching by pressing the electrode film passing between the first pressing roller and the second pressing roller against the second pressing roller.

7. The electrode manufacturing apparatus of claim 6, wherein
the first pressing roller includes a roller body having a cylindrical shape and a magnet portion installed on the roller body and having magnetism, and
the notching member is attached on the first pressing roller by the magnet portion of the first pressing roller.

8. The electrode manufacturing apparatus of claim 7, wherein
the notching member includes a material and structure that are elastically bendable so as to be bent and attached to match the outer diameter of the roller body by the magnetism of the magnet portion of the first pressing roller.

9. The electrode manufacturing apparatus of claim 7, wherein
a guide protrusion in the form of a protrusion is formed on one of the first pressing roller and the notching member and a guide groove into which the guide protrusion is fitted is formed on the other one of the first pressing roller and the notching member so as to guide the position of the notching member relative to the first pressing roller when the notching member is attached to the first pressing roller.

10. The electrode manufacturing apparatus of claim 6, wherein
the first pressing roller further includes a roller body having a cylindrical shape and a mounting portion formed concavely on the roller body, and
the notching member is fitted into the mounting portion of the first pressing roller such that a position of the notching member is fixed.
